(19) United States
(12) Patent Application Publication
(10) Pub. No.: US 2026/0131359 A1
(43) Pub. Date: May 14, 2026

(54) MATERIAL SELF-ADAPTIVE FLIP-FLOW DEVICE BASED ON NON-CONTACT MEASUREMENT AND SCREENING METHOD

(71) Applicant: China University of Mining and Technology, Xuzhou (CN)

(72) Inventors: Chenlong DUAN, Xuzhou (CN); Weinan WANG, Xuzhou (CN); Songxue ZHANG, Xuzhou (CN); Guofu DAI, Xuzhou (CN); Xu HOU, Xuzhou (CN); Pengfei MAO, Xuzhou (CN); Jiahao PAN, Xuzhou (CN)

(73) Assignee: China University of Mining and Technology, Xuzhou (CN)

(21) Appl. No.: 19/384,822

(22) Filed: Nov. 10, 2025

(30) Foreign Application Priority Data
Nov. 13, 2024 (CN) 202411614775.8

(51) Int. Cl. B07B 1/42; B07B 1/28

(52) U.S. Cl. CPC B07B 1/42; B07B 1/284

(57) ABSTRACT

The present disclosure relates to a material self-adaptive flip-flow device based on non-contact measurement and a screening method, belonging to the technical field of mineral screening. It solves the problem in the prior art that flip-flow screens cannot adapt to the characteristics of the feed materials. The disclosure includes a flip-flow screen, a non-contact measurement mechanism and a counterweight adjustment mechanism. The flip-flow screen includes a fixed frame and a floating frame, with the floating frame connected to the fixed frame. The counterweight adjustment mechanism includes a counterweight connected to the floating frame. The non-contact measurement mechanism is located on one side of the flip-flow screen and is used to acquire the motion characteristics of the fixed frame and the floating frame. The motion characteristics are used to adjust the counterweight.

### CROSS-REFERENCE TO RELATED APPLICATIONS

This application claims priority to Chinese Patent Application No. 202411614775.8, filed on Nov. 13, 2024, which is hereby incorporated by reference in its entireties.

### TECHNICAL FIELD

The present disclosure relates to the technical field of mineral screening, and more particularly, to a material self-adaptive flip-flow device based on non-contact measurement and a screening method.

### BACKGROUND

Screening is a key link in the clean and efficient utilization of mineral resources, mainly used for mineral classification, dewatering, and desliming operations. A flip-flow screen is a new type of screen that uses a screen surface made of polyurethane elastic material to perform flip-flow motion. The flexible screen surface periodically tightens and relaxes, and the vibration intensity of the screen surface can reach 50 g (1 g represents 9.8 m/s²), allowing the materials on the screen surface to be fully loosened and screened. Because the flexible screen surface is made of elastic material, the screen holes deform to a certain extent during the screening process, alleviating the problem of material blinding. Flip-flow screens have been widely used in recent years for deep screening of mineral resources.

For vibration detection of screening equipment, contact measurement (vibration testing, strain, or stress measurement) is mostly used. This measurement method has the following disadvantages: it can only test the area where the sensors are placed, cannot measure the entire area, and has a narrow measurement range; the sensors are arranged on the screen surface, and due to inertia, the measured screen surface vibration signals are distorted; in contact measurement, limited by the installation method and surface contact conditions, the stability is poor and the detection efficiency is low.

During normal operation of the flip-flow screen, the operating parameters are fixed, resulting in a single operating condition for materials with different characteristics. The flip-flow screen lacks adjustment mechanisms for operating parameters such as relative amplitude. When material characteristics such as processing capacity, particle size composition, moisture, and hardness change, automatic adjustment cannot be performed. When the screening material characteristics change significantly, the original vibration condition can no longer achieve efficient screening.

### SUMMARY

In view of the above analysis, the embodiments of the present disclosure aim to provide a material self-adaptive flip-flow device based on non-contact measurement and a screening method, to solve the problems that existing flip-flow screens cannot adapt to the characteristics of the feed material.

On one hand, the present disclosure provides a material self-adaptive flip-flow device based on non-contact measurement, includes a flip-flow screen, a non-contact measurement mechanism and a counterweight adjustment mechanism; wherein the flip-flow screen includes a fixed frame and a floating frame, with the floating frame connected to the fixed frame; the counterweight adjustment mechanism includes a counterweight connected to the floating frame; the non-contact measurement mechanism is arranged on one side of the flip-flow screen and is used to acquire motion characteristics of the fixed frame and the floating frame; the motion characteristics are used to adjust the counterweight.

Further, the non-contact measurement mechanism includes a guide rail seat, a protective box, an industrial camera, and a lifting assembly; the protective box is arranged at one end of the guide rail seat; the industrial camera is arranged at a top of the lifting assembly, and a bottom of the lifting assembly moves along the guide rail seat.

Further, the guide rail seat includes a base plate, a V-shaped guide rail and an arc-shaped guide rail; the protective box is arranged on the base plate; the V-shaped guide rail and the arc-shaped guide rail are parallelly arranged on a top of the base plate.

Further, the lifting assembly further includes a first lifting cylinder, a second lifting cylinder and a third lifting cylinder arranged sequentially from bottom to top; the industrial camera is arranged at a top of the third lifting cylinder.

Further, the lifting assembly further includes first rollers and second rollers; both the first rollers and the second rollers are arranged at a bottom of the first lifting cylinder.

Further, the first rollers roll along the V-shaped guide rail, and the second rollers roll along the arc-shaped guide rail.

Further, a lower end of the second lifting cylinder slides within the first lifting cylinder, and a lower end of the third lifting cylinder slides within the second lifting cylinder.

Further, the flip-flow screen further includes a first mounting base, first support columns, and second support columns; a height of the first support columns is less than a height of the second support columns; lower ends of both the first support columns and the second support columns are connected to the first mounting base.

Further, upper ends of the first support columns and upper ends of the second support columns are both connected to the fixed frame.

On the other hand, the present disclosure provides a material self-adaptive screening method, using the aforementioned self-adaptive flip-flow device to perform self-adaptive screening of materials.

Compared with the prior art, the present disclosure can achieve at least one of the following beneficial effects:
(1) The non-contact measurement mechanism of the present disclosure is located on one side of the flip-flow screen and is used to acquire the motion characteristics of the fixed frame and the floating frame. The counterweight of the counterweight adjustment mechanism is connected to the floating frame. The counterweight is adjusted according to the motion characteristics, thereby achieving adjustment of the relative amplitude of the floating frame, enabling the flip-flow screen to self-adaptively match different types of screening materials, and adapting to changes in characteristics of different materials such as processing capacity, particle size composition, moisture, and hardness, thereby achieving efficient screening. Non-contact measurement ensures measurement accuracy.
(2) The present disclosure tracks the identified targets, uses a loop algorithm to identify each frame of the image, establishes an array to store the position information of the centroid of each frame. After the loop calculation is completed, the motion trajectory of the tracked targets are drawn based on the data in the array, preserving the fluctuation of the screen machine's motion during actual operation, unaffected by filtering, resulting in more accurate monitoring of the motion trajectory.
(3) The lifting assembly of the present disclosure includes support bases, gears, swing rods, and support rods. Four support bases are uniformly distributed around the annular fixed seat. The gears mesh with the rotating seat. One end of the swing rod passes through the support base and is connected to the gear, and the other end is hinged to the lower end of the support rod. The upper end of the support rod is hinged to the bottom of the second lifting cylinder. The inner ring wall surface of the annular fixed seat is provided with a first arc-shaped groove. The outer side wall of the rotating seat is provided with a second arc-shaped groove. A gap is provided between the rotating seat and the annular fixed seat. A plurality of balls are provided between the first arc-shaped groove and the second arc-shaped groove. The rotation of the rotating seat synchronously drives the four swing rods to swing, thereby driving the four support rods to swing synchronously, achieving stable lifting of the second lifting cylinder within the first lifting cylinder.

In the present disclosure, the various technical solutions can also be combined with each other to achieve more preferred combination solutions. Other features and advantages of the present disclosure will be set forth in the subsequent description, and partly, will become obvious from the description, or be understood by implementing the present disclosure. The objectives and other advantages of the present disclosure may be realized and attained by the description and the drawings.

### BRIEF DESCRIPTION OF THE DRAWINGS

The drawings are only for the purpose of illustrating specific embodiments and are not to be considered as limiting the present disclosure. Throughout the drawings, the same reference symbols denote the same components.

FIG. 1 is structural schematic diagram of the material self-adaptive flip-flow device (excluding the counterweight adjustment mechanism) according to Specific Embodiment 1;

FIG. 2 is connection structure diagram of the counterweight adjustment mechanism and part of the flip-flow screen according to Specific Embodiment 1;

FIG. 3 is structural schematic diagram of the non-contact measurement mechanism according to Specific Embodiment 1;

FIG. 4 is connection structure diagram of the second lifting cylinder and its lifting components according to Specific Embodiment 1;

FIG. 5 is structural diagram of the lifting components for the second lifting cylinder according to Specific Embodiment 1;

FIG. 6 is connection structure diagram of the rotating seat, annular fixed seat, rotating shaft, and support bases on the first lifting cylinder base plate according to Specific Embodiment 1;

FIG. 7 is connection structure diagram of the annular fixed seat, balls, and support bases on the first lifting cylinder base plate according to Specific Embodiment 1;

FIG. 8 is structural diagram of the rotating seat according to Specific Embodiment 1;

FIG. 9 is structural diagram of the first lifting cylinder according to Specific Embodiment 1;

FIG. 10 is first structural diagram of the second lifting cylinder according to Specific Embodiment 1;

FIG. 11 is second structural diagram of the second lifting cylinder according to Specific Embodiment 1;

FIG. 12 is structural diagram of the third lifting cylinder according to Specific Embodiment 1;

FIG. 13 is connection structure diagram of the screw rod, second mounting base, and second motor according to Specific Embodiment 1;

FIG. 14A and FIG. 14B are identification schematic diagram of the marker points located in the middle end area of the fixed frame according to Specific Embodiment 2;

FIG. 15 is motion trajectory diagram of the tracked target within 2 cycles according to Specific Embodiment 2.

### REFERENCE SIGNS

100—Flip-flow screen; 101—First mounting base; 102—First support column; 103—Second support column; 104—Fixed frame; 105—Floating frame; 106—Shear Spring; 107—First connecting plate; 108—Flexible screen surface; 109—Vibration motor; 110—Second connecting plate;
200—Non-contact measurement mechanism; 201—Guide rail seat; 202—Protective box; 203—Industrial camera; 204—Lifting assembly; 205—Base plate; 206—V-shaped guide rail; 207—Arc-shaped guide rail; 208—Primary lifting cylinder; 209—Secondary lifting cylinder; 210—Tertiary lifting cylinder; 211—First roller; 212—Second roller; 213—Rotating seat; 214—First motor; 215—Rotating shaft; 216—Annular fixed seat; 217—First arc-shaped groove; 218—Second arc-shaped groove; 219—Ball; 220—Support base; 221—Gear; 222—Swing rod; 223—Support rod; 224—First guide groove; 225—Connecting platform; 226—Connecting column; 227—First guide rail; 228—Second guide groove; 229—Second motor; 230—Second mounting base; 231—Screw rod; 232—Second guide rail;
300—Counterweight adjustment mechanism; 301—Counterweight; 302—Oil outlet pipe; 303—Oil inlet pipe; 304—Hydraulic oil tank; 305—Hydraulic oil pump; 306—Oil delivery pipe; 307—Solenoid valve.

### DETAILED DESCRIPTION OF THE EMBODIMENTS

The preferred embodiments of the present disclosure are described in detail below with reference to the accompanying drawings. The accompanying drawings form a part of the present disclosure and are used together with the embodiments of the present disclosure to explain the principles of the present disclosure, and are not intended to limit the scope of the present disclosure.

### Embodiment 1

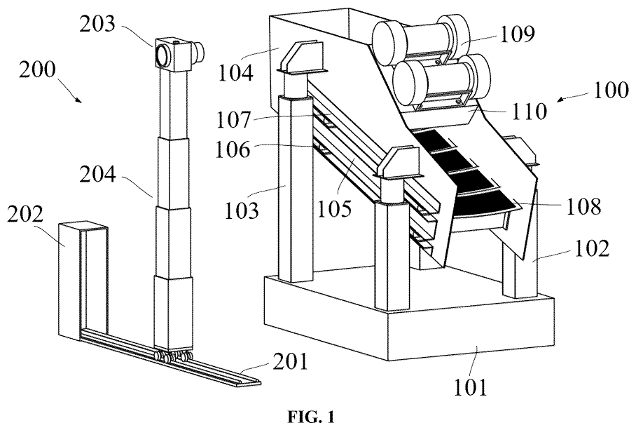

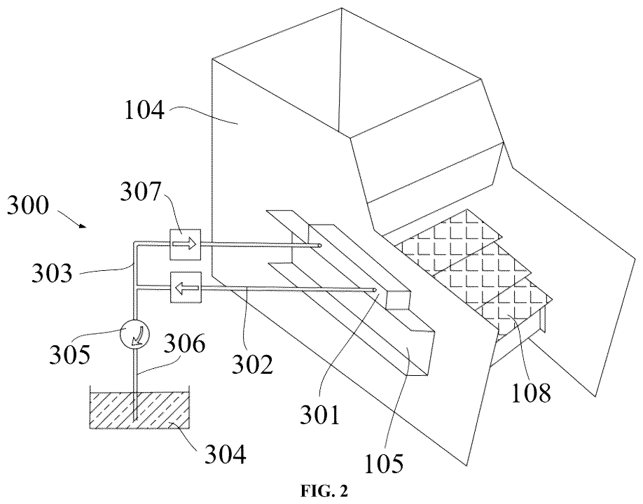

A specific embodiment of the present disclosure, as shown in FIGS. 1 and 2, discloses a material self-adaptive flip-flow device based on non-contact measurement, comprising a flip-flow screen 100, a non-contact measurement mechanism 200, and a counterweight adjustment mechanism 300. The non-contact measurement mechanism 200 is located on one side of the flip-flow screen 100 and is used to acquire the motion characteristics of the flip-flow screen 100. Based on the motion characteristics, the relative amplitude of the floating frame 105 is adjusted, enabling the flip-flow screen 100 to adapt to different types of screening materials and achieve self-adaptation. The counterweight 301 of the counterweight adjustment mechanism 300 is connected to the floating frame 105.

Compared with the prior art, the material self-adaptive flip-flow device provided in this embodiment has the non-contact measurement mechanism 200 located on one side of the flip-flow screen 100 to acquire the motion characteristics of the fixed frame 104 and the floating frame 105. The counterweight 301 of the counterweight adjustment mechanism 300 is connected to the floating frame 105. The counterweight 301 is adjusted according to the motion characteristics, thereby achieving adjustment of the relative amplitude of the floating frame 105, enabling the flip-flow screen 100 to self-adaptively match different types of screening materials, and adapting to changes in characteristics of different materials such as processing capacity, particle size composition, moisture, and hardness, thereby achieving efficient screening. Non-contact measurement ensures measurement accuracy.

As shown in FIG. 1, the flip-flow screen 100 includes a first mounting base 101, first support columns 102, and second support columns 103. Both the first support columns 102 and the second support columns 103 are provided in two. The height of the first support column 102 is less than the height of the second support column 103. The lower ends of both the first support columns 102 and the second support columns 103 are connected to the first mounting base 101.

As shown in FIG. 1, the flip-flow screen 100 further includes a fixed frame 104, a floating frame 105, and shear springs 106. The two first support columns 102 are located on both front sides of the fixed frame 104. The two second support columns 103 are located on both rear sides of the fixed frame 104. The upper ends of the first support columns 102 are connected to the front end of the fixed frame 104. The upper ends of the second support columns 103 are connected to the rear end of the fixed frame 104. The floating frame 105 is connected to the fixed frame 104 via the shear springs 106. A plurality of shear springs 106 are provided. Shear springs 106 are arranged on both the upper and lower sides of the floating frame 105.

Specifically, the fixed frame 104 is provided with slot holes. The middle part of the floating frame 105 is located in the middle space of the fixed frame 104. The two sides of the floating frame 105 are located in the slot holes and extend outward from the two outer side walls of the fixed frame 104. Two first connecting plates 107 are provided on each of the two outer side walls of the fixed frame 104, located on the upper and lower sides of the slot holes. One end of the shear spring 106 is connected to the first connecting plate 107, and the other end is connected to the floating frame 105. It should be noted that the connection positions of the first support columns 102 and the second support columns 103 with the fixed frame 104 are all located above the floating frame 105.

As shown in FIG. 1, the flip-flow screen 100 further includes a flexible screen surface 108 and a vibration motor 109. The flexible screen surface 108 is arranged on the cross beam of the floating frame 105. The vibration motor 109 is connected to the fixed frame 104 via a second connecting plate 110.

In this embodiment, the floating frame 105 is connected to the fixed frame 104 via the shear springs 106. Under the action of the vibration motor 109, based on the double-mass sub-resonance principle, the floating frame 105 generates a phase difference with the fixed frame 104, causing the elastic screen surface to periodically relax and tighten. The flip-flow motion of the elastic screen surface provides a high throwing intensity to the material on the screen surface, promoting material stratification and screening.

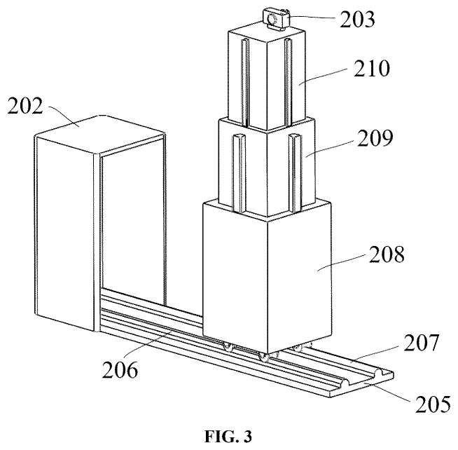

As shown in FIGS. 1 and 3, the non-contact measurement mechanism 200 includes a guide rail seat 201, a protective box 202, an industrial camera 203, and a lifting assembly 204. The protective box 202 is located at one end of the guide rail seat 201. The industrial camera 203 is located at the top of the lifting assembly 204. The bottom of the lifting assembly 204 moves along the guide rail seat 201. When shooting is not required, the lifting assembly 204 moves with the industrial camera 203 into the protective box 202.

As shown in FIG. 3, the guide rail seat 201 includes a base plate 205, a V-shaped guide rail 206, and an arc-shaped guide rail 207. The V-shaped guide rail 206 and the arc-shaped guide rail 207 are arranged parallel on the top of the base plate 205 and extend into the inner cavity of the protective box 202, allowing the lifting assembly 204 to move with the industrial camera 203 into the protective box 202. In this embodiment, the V-shaped guide rail 206 has high guiding accuracy, can automatically compensate for wear, and is conducive to chip removal. The arc-shaped guide rail 207 is easy to install.

As shown in FIG. 3, the lifting assembly 204 includes a first lifting cylinder 208, a second lifting cylinder 209, and a third lifting cylinder 210. The first lifting cylinder 208, second lifting cylinder 209 and third lifting cylinder 210 are arranged sequentially from bottom to top. The lower part of the second lifting cylinder 209 can lift within the first lifting cylinder 208. The lower part of the third lifting cylinder 210 can lift within the second lifting cylinder 209. The industrial camera 203 is arranged at the top of the third lifting cylinder 210. It should be noted that, according to actual needs, the lifting assembly 204 can also include a fourth lifting cylinder, a fifth lifting cylinder, etc.

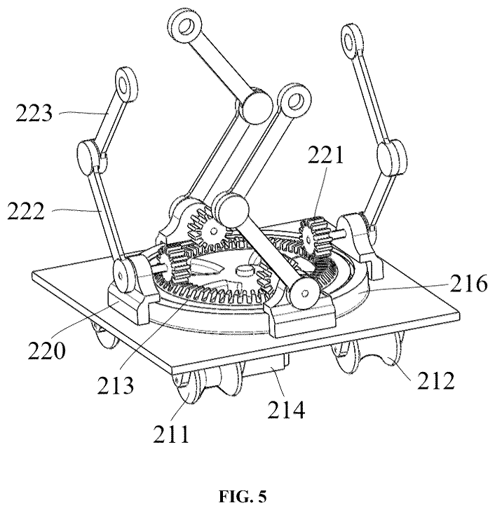

As shown in FIGS. 3, 4, and 5, the lifting assembly 204 further includes first rollers 211 and second rollers 212. Both the first rollers 211 and the second rollers 212 are located at the bottom of the first lifting cylinder 208, and both the first rollers 211 and the second rollers 212 are provided in two. The first rollers 211 roll along the V-shaped guide rail 206, and the second rollers 212 roll along the arc-shaped guide rail 207.

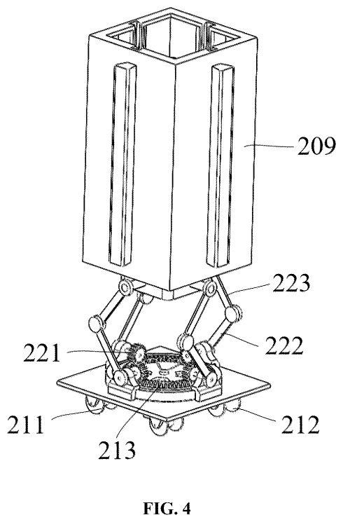

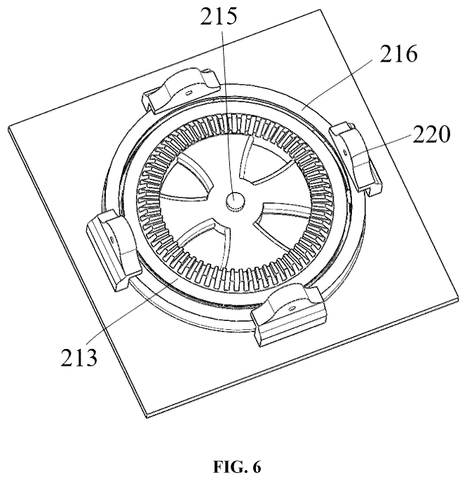

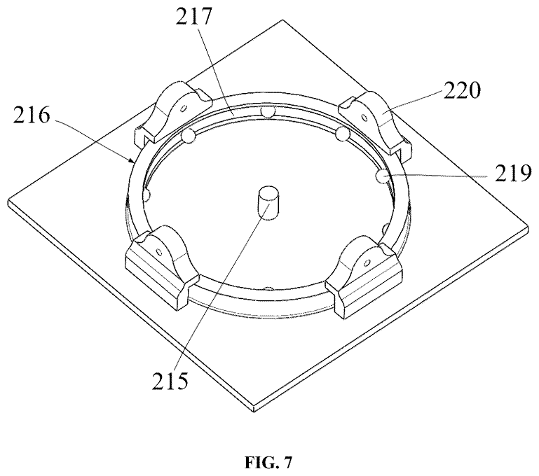

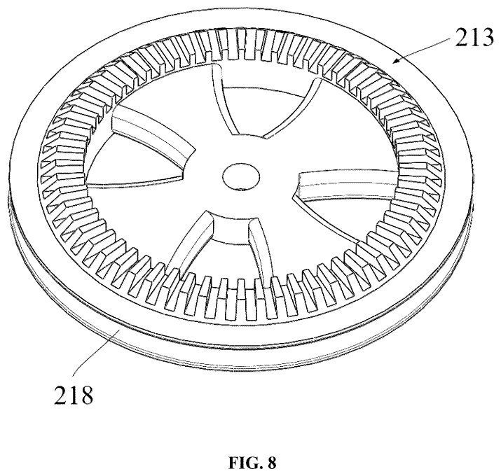

Referring to FIGS. 4, 5, 6, 7, and 8, the lifting assembly 204 further includes a rotating seat 213, a first motor 214, and a rotating shaft 215. The first motor 214 is connected to the rotating shaft 215 and drives the rotating shaft 215 to rotate. The rotating seat 213 is installed on the rotating shaft 215 and rotates synchronously with the rotating shaft 215. The first motor 214 is installed at the bottom of the first lifting cylinder 208. The base plate of the first lifting cylinder 208 is provided with an annular fixed seat 216. The inner ring wall surface of the annular fixed seat 216 is provided with a first arc-shaped groove 217. The outer side wall of the rotating seat 213 is provided with a second arc-shaped groove 218. A gap is provided between the rotating seat 213 and the annular fixed seat 216. A plurality of balls 219 are provided between the first arc-shaped groove 217 and the second arc-shaped groove 218, and the balls 219 roll in the space between the first arc-shaped groove 217 and the second arc-shaped groove 218. It should be noted that, to restrict the spacing between the balls 219, a ball support frame (not shown in the figure) is provided between the first arc-shaped groove 217 and the second arc-shaped groove 218.

In this embodiment, the first arc-shaped groove 217 is provided on the inner side wall of the annular fixed seat 216, the second arc-shaped groove 218 is provided on the outer side wall of the rotating seat 213, and balls 219 are provided between the first arc-shaped groove 217 and the second arc-shaped groove 218, which supports the rotating seat 213 and also facilitates the rotation of the rotating seat 213.

Referring to FIGS. 4, 5, and 6, the lifting assembly 204 further includes four support bases 220, four gears 221, four swing rods 222, and four support rods 223. The support bases 220 are arranged on the base plate of the first lifting cylinder 208. The four support bases 220 are uniformly distributed around the annular fixed seat 216. The gears 221 mesh with the rotating seat 213. Understandably, the upper part of the rotating seat 213 is provided with teeth that mesh with the gears 221. The swing rod 222 is L-shaped. One end of the swing rod 222 passes through the support base 220 and is connected to the gear 221, and the other end is hinged to the lower end of the support rod 223. The upper end of the support rod 223 is hinged to the bottom of the second lifting cylinder 209.

It is worth noting that the support base 220, gear 221, swing rod 222, and support rod 223 form a set of transmission mechanism, and four sets are provided, uniformly distributed around the circumference of the annular fixed seat 216. The rotation of the rotating seat 213 synchronously drives the four swing rods 222 to swing, thereby driving the four support rods 223 to swing synchronously, achieving the lifting of the second lifting cylinder 209. Understandably, the swing direction and angle of the four swing rods 222 are the same, and the swing direction and angle of the four support rods 223 are also the same.

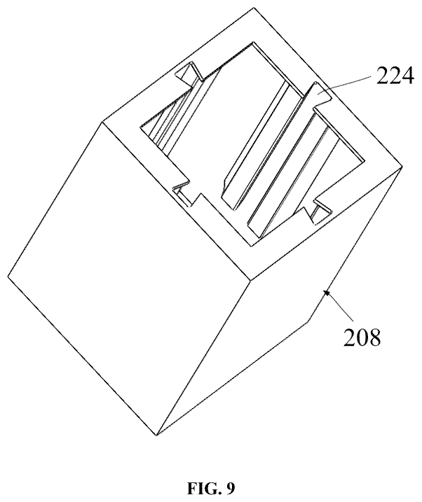

The second lifting cylinder 209 lifts within the first lifting cylinder 208. To guide the second lifting cylinder 209 and restrict degrees of freedom in other directions, as shown in FIG. 9, the inner wall of the first lifting cylinder 208 is provided with first guide grooves 224. Understandably, four first guide grooves 224 are correspondingly distributed on the four inner walls of the first lifting cylinder 208. Preferably, the first guide grooves 224 are dovetail grooves. The lower end of the first guide groove 224 is shorter than the lower end of the first lifting cylinder 208.

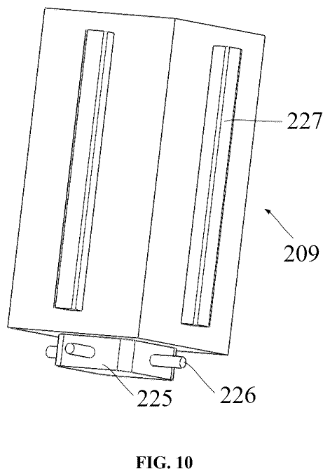

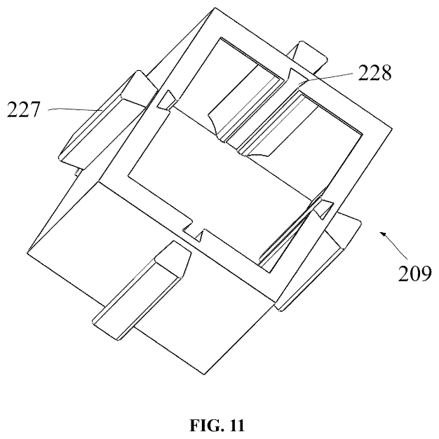

To connect with the support rods 223, as shown in FIGS. 4, 10, and 11, the bottom of the second lifting cylinder 209 is provided with a connecting platform 225. The periphery of the connecting platform 225 is provided with connecting columns 226. The connecting columns 226 are hinged to the upper ends of the support rods 223. The outer wall of the second lifting cylinder 209 is provided with first guide rails 227. The first guide rails 227 cooperate with the first guide grooves 224. The first guide rails 227 slide up and down within the first guide grooves 224. To restrict degrees of freedom of the third lifting cylinder 210 in other directions, the inner wall of the second lifting cylinder 209 is provided with second guide grooves 228. Preferably, the second guide grooves 228 are dovetail grooves.

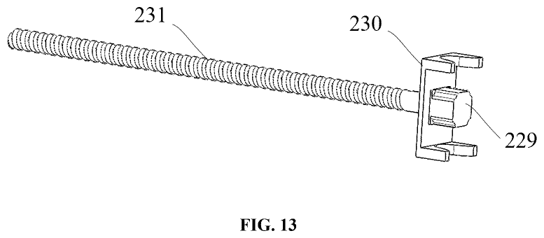

As shown in FIG. 13, the lifting assembly 204 further includes a second motor 229, a second mounting base 230, and a screw rod 231. The second motor 229 is installed on the second mounting base 230. The second mounting base 230 is installed at the bottom of the second lifting cylinder 209. The lower end of the screw rod 231 is connected to the second motor 229. The upper end of the screw rod 231 is threadedly connected to the bottom of the third lifting cylinder 210.

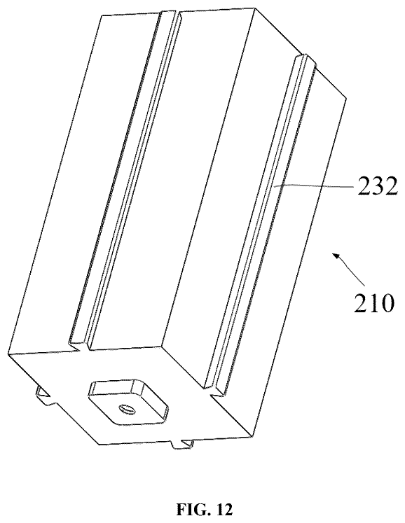

As shown in FIG. 12, the outer wall of the third lifting cylinder 210 is provided with second guide rails 232. The second guide rails 232 slide within the second guide grooves 228. The second motor 229 drives the screw rod 231 to rotate. Since the third lifting cylinder 210 is connected to the second lifting cylinder 209 via the second guide rails 232 and the second guide grooves 228, the rotational degree of freedom of the third lifting cylinder 210 is restricted. The rotation of the screw rod 231 drives the third lifting cylinder 210 to move up and down along the second lifting cylinder 209.

During normal operation of the flip-flow screen 100, the flexible screen surface 108 performs periodic motion driven by the fixed frame 104 and the cross beams of the floating frame 105. However, the properties of the screening materials are not stable, so a single throwing intensity cannot guarantee the screening efficiency for materials with different properties. The flip-flow motion characteristics of the flexible screen surface 108 depend on the relative motion characteristics of the fixed frame 104 and the floating frame 105, among which the mass of the floating frame 105 is a critical factor. In order to enable the throwing intensity of the flip-flow screen 100 to be adjusted according to the working conditions of different materials, achieving efficient screening adapted to materials of different properties, the material self-adaptive flip-flow device is provided with a counterweight adjustment mechanism 300. As shown in FIG. 2, the counterweight adjustment mechanism 300 includes a counterweight 301, an oil outlet pipe 302, an oil inlet pipe 303, a hydraulic oil tank 304, and a hydraulic oil pump 305. The counterweight 301 is arranged on the floating frame 105. The counterweight 301 is provided with an oil storage space inside. One end of the oil outlet pipe 302 is connected to the oil storage space inside the counterweight 301, and the other end is connected to the hydraulic oil pump 305. One end of the oil inlet pipe 303 is connected to the oil storage space inside the counterweight 301, and the other end is connected to the oil outlet pipe 302. The counterweight adjustment mechanism 300 further includes an oil delivery pipe 306 connecting the hydraulic oil pump 305 and the hydraulic oil tank 304. When part of the oil in the counterweight 301 is pumped out, the weight of the counterweight 301 decreases. When oil is delivered to the oil storage space inside the counterweight 301, the weight of the counterweight 301 increases. Understandably, both the oil outlet pipe 302 and the oil inlet pipe 303 are provided with solenoid valves 307.

In this embodiment, by providing the counterweight adjustment mechanism 300 on the floating frame 105 to adjust the counterweight 301 of the floating frame 105, the relative motion between the floating frame 105 and the fixed frame 104 is adjusted, achieving the purpose of adjusting the throwing intensity of the flip-flow screen 100, enabling the flip-flow screen 100 to adapt to screening materials of different properties.

It should be noted that the material self-adaptive flip-flow device further includes a controller (such as an industrial computer), which is used for image processing and control of the vibration motor 109, industrial camera 203, first motor 214, second motor 229, hydraulic oil pump 305, and solenoid valves 307.

### Embodiment 2

Another specific embodiment of the present disclosure discloses a material self-adaptive screening method based on non-contact measurement, using the material self-adaptive flip-flow device of Embodiment 1 to perform self-adaptive screening of materials, comprising the following steps:

Step 1: Adjust the height of the industrial camera 203 to collect images of marker points on the side plate of the fixed frame 104 and the side plate of the floating frame 105 during stable screening operation.

To obtain motion information of key parts of the screen body such as the side plate of the fixed frame 104 and the side plate of the floating frame 105, marker points are set at positions such as the feed end of the fixed frame 104 side plate, the middle end of the fixed frame 104 side plate, the discharge end of the fixed frame 104 side plate, the feed end of the floating frame 105 side plate, the middle end of the floating frame 105 side plate, and the discharge end of the floating frame 105 side plate. The industrial camera 203 vision system is used to capture and collect image information.

Step 2: Process the collected image information.

Step 2.1: Target identification.

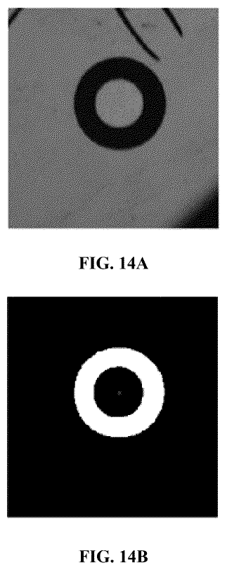

To avoid interference from other image information and ensure identification accuracy, first extract any captured frame of the image for target identification. Grayscale the image, and set the grayscale value for binary threshold segmentation to 50 according to the grayscale histogram. Perform limited area processing, use the regionprops function to measure the area of each connected component in the image, and set an area limit based on the measurement results to distinguish the marker point area from other areas. Obtain the centroid of the marker point as the identification target, and use the motion of the centroid to represent the motion of the marker point, thus completing target identification. As shown in FIG. 14A and FIG. 14B, FIG. 14A is a schematic diagram before identification of the marker point located in the middle end area of the fixed frame 104, and FIG. 14B is a schematic diagram after identification of the marker point located in the middle end area of the fixed frame 104.

Step 2.2: Target tracking.

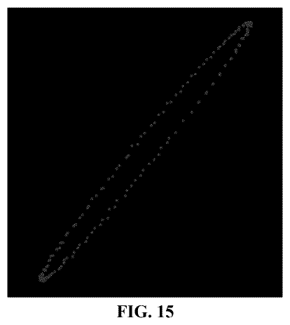

Track the identified targets, use a loop algorithm to identify each frame of the image, and establish an array to store the position information of the centroid of each frame. After the loop calculation is completed, draw the motion trajectory of the tracked targets (centroids) based on the data in the array. FIG. 15 shows the motion trajectory of the tracked target within 2 cycles. It can be seen that the trajectory is not strictly elliptical, and each position point has a certain range of fluctuation, indicating that the visual algorithm preserves the fluctuation of the screen machine's motion during actual operation. The monitored motion trajectory is more accurate and, compared with contact vibration testing, is not affected by filtering, so the accuracy is higher.

Step 3: Using the above target identification and tracking, obtain the displacement information of key parts of the screen body. Perform differential processing on the displacement signals to obtain kinematic information such as velocities and accelerations of key areas.

Step 4: Based on the obtained kinematic information of the fixed frame 104 and the floating frame 105, adjust the amplitude of the floating frame 105 to achieve material self-adaptation.

Step 4.1: Based on the kinematic information, obtain the relative motion amplitude between the marker point on the middle end of the fixed frame 104 side plate and the marker point on the middle end of the floating frame 105 side plate, as the relative amplitude between the fixed frame 104 and the floating frame 105.

Step 4.2: Adjust the counterweight 301 to test the screening effect and select the relative amplitude range.

Select the material with the highest on-site output as the test sample, adjust the counterweight 301 of the floating frame 105, and conduct screening tests on the test sample to determine which counterweight 301 has the best screening effect on the test sample. Select the comprehensive separation index as the evaluation indicator. As the relative amplitude increases, the comprehensive separation index should first increase and then decrease, so select the relative amplitude range of the two tests with the highest comprehensive separation index as the optimal range. Based on the relative amplitude range captured by the non-contact measurement mechanism 200, set this amplitude range as the reasonable working range for the relative motion amplitude between the floating frame 105 and the fixed frame 104.

Step 4.3: According to the relative amplitude range, adjust the counterweight adjustment mechanism 300 to adapt to different types of materials.

When screening a certain material, use the difference in relative motion amplitude captured by the non-contact measurement mechanism 200 to determine whether the relative amplitude is within the reasonable working range. When the relative amplitude is not within the range, use the counterweight adjustment mechanism 300 to adjust the counterweight 301 on the floating frame 105 to change the amplitude of the floating frame 105. Specifically, when the relative amplitude is greater than the range, increase the counterweight 301 on the floating frame 105 to reduce the motion amplitude of the floating frame 105; when the relative amplitude is less than the range, decrease the counterweight 301 on the floating frame 105 to increase the motion amplitude of the floating frame 105.

For materials with different processing capacities: when the material increases and the processing capacity increases, the non-contact measurement mechanism 200 will monitor that the relative amplitude is less than the reasonable working range, so it is necessary to reduce the counterweight 301 on the floating frame 105 to increase the relative motion amplitude until the relative amplitude is within the reasonable working range. Conversely, when the processing capacity decreases.

For materials with different particle sizes: when the raw coal screening test results show that there are more materials close to the screen hole size, including obstructing particles (particle size 1-1.5 times the screen hole size) and difficult-to-screen particles (particle size 0.75-1 times the screen hole size), which leads to poor screening efficiency, the relative motion amplitude should be increased to increase the throwing intensity of the screen surface, so the counterweight 301 on the floating frame 105 should be reduced.

For materials with different hardness: when the material hardness is higher than that of the test sample material, to avoid material impact damage, increase the counterweight 301 on the floating frame 105 to reduce the relative motion amplitude.

For materials with different moisture content: when the material moisture content is higher than that of the test sample material, to improve screening efficiency, reduce the counterweight 301 on the floating frame 105 to reduce the relative motion amplitude.

Through the above method of non-contact measurement of relative amplitude and adjustment of the counterweight 301 on the floating frame 105 to adjust the relative amplitude, the flip-flow screen 100 is adapted to different types of screening materials, achieving self-adaptation.

The above description is only preferred specific embodiments of the present disclosure, but the scope of protection of the present disclosure is not limited thereto. Any changes or substitutions that can be easily conceived by those skilled in the art within the technical scope disclosed in the present disclosure shall be covered within the protection scope of the present disclosure.

What is claimed is:

1. A material self-adaptive flip-flow device based on non-contact measurement, comprising a flip-flow screen, a non-contact measurement mechanism and a counterweight adjustment mechanism; wherein the flip-flow screen comprises a fixed frame and a floating frame, with the floating frame connected to the fixed frame; the counterweight adjustment mechanism comprises a counterweight connected to the floating frame; the non-contact measurement mechanism is arranged on one side of the flip-flow screen and is used to acquire motion characteristics of the fixed frame and the floating frame; the motion characteristics are used to adjust the counterweight.

2. The material self-adaptive flip-flow device based on non-contact measurement according to claim 1, wherein the non-contact measurement mechanism comprises a guide rail seat, a protective box, an industrial camera, and a lifting assembly; the protective box is arranged at one end of the guide rail seat; the industrial camera is arranged at a top of the lifting assembly, and a bottom of the lifting assembly moves along the guide rail seat.

3. The material self-adaptive flip-flow device based on non-contact measurement according to claim 2, wherein the guide rail seat comprises a base plate, a V-shaped guide rail and an arc-shaped guide rail; the protective box is arranged on the base plate; the V-shaped guide rail and the arc-shaped guide rail are parallelly arranged on a top of the base plate.

4. The material self-adaptive flip-flow device based on non-contact measurement according to claim 3, wherein the lifting assembly further comprises a first lifting cylinder, a second lifting cylinder and a third lifting cylinder arranged sequentially from bottom to top; the industrial camera is arranged at a top of the third lifting cylinder.

5. The material self-adaptive flip-flow device based on non-contact measurement according to claim 4, wherein the lifting assembly further comprises first rollers and second rollers; both the first rollers and the second rollers are arranged at a bottom of the first lifting cylinder.

6. The material self-adaptive flip-flow device based on non-contact measurement according to claim 5, wherein the first rollers roll along the V-shaped guide rail, and the second rollers roll along the arc-shaped guide rail.

7. The material self-adaptive flip-flow device based on non-contact measurement according to claim 4, wherein a lower end of the second lifting cylinder slides within the first lifting cylinder, and a lower end of the third lifting cylinder slides within the second lifting cylinder.

8. The material self-adaptive flip-flow device based on non-contact measurement according to claim 1, wherein the flip-flow screen further comprises a first mounting base, first support columns, and second support columns; a height of the first support columns is less than a height of the second support columns; lower ends of both the first support columns and the second support columns are connected to the first mounting base.

9. The material self-adaptive flip-flow device based on non-contact measurement according to claim 8, wherein upper ends of the first support columns and upper ends of the second support columns are both connected to the fixed frame.

10. A material self-adaptive screening method, wherein using the material self-adaptive flip-flow device according to claim 1 to perform self-adaptive screening of materials.
